(19) United States
(12) Patent Application Publication
(10) Pub. No.: US 2026/0299879 A1
(43) Pub. Date: Oct. 1, 2026

(54) ELECTRONIC APPARATUS AND METHOD FOR OPERATING THEREOF AND STORAGE MEDIUM

(71) Applicant: SAMSUNG ELECTRONICS CO., LTD., Suwon-si (KR)

(72) Inventors: Jongbae KIM, Suwon-si (KR); Sunmin Kim, Suwon-si (KR)

(73) Assignee: SAMSUNG ELECTRONICS CO., LTD., Suwon-si (KR)

(21) Appl. No.: 19/557,705

(22) Filed: Mar. 5, 2026

Related U.S. Application Data
(63) Continuation of application No. PCT/KR2026/002793, filed on Feb. 13, 2026.

(30) Foreign Application Priority Data
Mar. 25, 2025 (KR) 10-2025-0038072

(51) Int. Cl. G06F 3/16; G06K 7/10

(52) U.S. Cl. CPC G06F 3/165; G06F 3/162; G06K 7/10297

(57) ABSTRACT

An electronic apparatus includes: a communication circuit; a speaker; at least one processor comprising a processing circuit, wherein the at least one processor is operatively connected with the communication circuit and the speaker; and a memory storing instructions, wherein, when the instructions are executed by the at least one processor individually or collectively, the instructions cause the electronic apparatus to: identify whether an object corresponding to an audio content is attached to a first position of the electronic apparatus, acquire metadata corresponding to the audio content from the object through the communication circuit, obtain, from an external apparatus through the communication circuit, the audio content corresponding to the acquired metadata, and output, through the speaker, the obtained audio content.

### CROSS REFERENCE TO RELATED APPLICATIONS

This application is a by-pass continuation application of International Application No. PCT/KR2026/002793, filed on Feb. 13, 2026, which is based on and claims priority to Korean Patent Application No. 10-2025-0038072, filed on Mar. 25, 2025, in the Korean Intellectual Property Office, the disclosures of which are incorporated by reference herein their entireties.

### BACKGROUND

### 1. Field

The present disclosure relates to an electronic apparatus, a method for operating the electronic apparatus, and a storage medium, and more particularly, to an electronic apparatus, a method for operating the electronic apparatus, and a storage medium that provide a media content.

### 2. Description of Related Art

As music enjoyment through mobile devices becomes widespread and streaming services advance, the necessity for conventional legacy media such as long-playing records (LPs) or compact discs (CDs) is decreasing. However, LP sales are actually increasing due to nostalgia for the past, a sense of ownership over music sources, and the visual satisfaction provided by LP jackets. Accordingly, solutions are emerging to provide an analog music listening experience while enhancing user convenience.

The above information may be provided as related art for the purpose of facilitating understanding of the present disclosure. No assertion or determination is made as to whether any of the above information can be applied as prior art related to the present disclosure.

### SUMMARY

According to an aspect of the disclosure, an electronic apparatus includes: a communication circuit; a speaker; at least one processor comprising a processing circuit, wherein the at least one processor is operatively connected with the communication circuit and the speaker; and a memory storing instructions, wherein, when the instructions are executed by the at least one processor individually or collectively, the instructions cause the electronic apparatus to: identify whether an object corresponding to an audio content is attached to a first position of the electronic apparatus, acquire metadata corresponding to the audio content from the object through the communication circuit, obtain, from an external apparatus through the communication circuit, the audio content corresponding to the acquired metadata, and output, through the speaker, the obtained audio content.

According to an aspect of the disclosure, a method for operating an electronic apparatus, includes: identifying whether an object corresponding to an audio content is attached to a first position of the electronic apparatus; acquiring, based on the object being attached, metadata corresponding to the audio content from the object through a communication circuit; obtaining, based on the acquired metadata, the audio content from an external apparatus through the communication circuit; and outputting, through a speaker, the audio content.

According to an aspect of the disclosure, an electronic apparatus includes: a communication circuit; an output device; at least one processor comprising a processing circuit, wherein the at least one processor is operatively connected with the communication circuit and the output device; and a memory storing instructions, wherein, when the instructions are executed by the at least one processor individually or collectively, the instructions cause the electronic apparatus to: identify whether an object corresponding to a media content is attached to a first position of the electronic apparatus, acquire metadata corresponding to the media content from the object through the communication circuit, obtain, from an external apparatus through the communication circuit, the media content corresponding to the acquired metadata, and output, through the output device, the obtained media content.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for schematically describing an electronic apparatus according to an embodiment;

FIG. 2 is a block diagram illustrating a configuration of the electronic apparatus according to an embodiment;

FIG. 3 is a flowchart for describing a method for operating the electronic apparatus according to an embodiment;

FIG. 4 is a flowchart for describing a method for acquiring a media content (e.g. an audio content) according to an embodiment;

FIG. 5 is a flowchart for describing a method for outputting a media content (e.g. an audio content) in a first operation mode according to an embodiment;

FIG. 6 is a diagram for describing a method for identifying whether an object is attached to a first position according to an embodiment;

FIG. 7 is a flowchart for describing a method for stopping playback of a media content (e.g. an audio content) according to an embodiment.

FIG. 8 is a flowchart for describing a method for outputting a mixed audio according to an embodiment;

FIG. 9 is a flowchart for describing a method for mixing an audio according to an embodiment;

FIG. 10 is a flowchart for describing a method for converting a media content (e.g. an audio content) according to an embodiment;

FIG. 11A is a diagram for describing a method for identifying an attachment direction of an object according to an embodiment;

FIG. 11B is a diagram for describing a method for identifying an attachment direction of an object according to an embodiment; and

FIG. 12 is a block diagram illustrating a detailed configuration of an electronic apparatus according to an embodiment.

### DETAILED DESCRIPTION

Hereinafter, the present disclosure will be described in detail with reference to the accompanying drawings. The same reference numerals are used throughout the drawings to denote the same or similar elements, features, and structures.

After terms used in the present specification are briefly described, the present disclosure will be described in detail.

General terms that are currently widely used were selected as terms used in embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “least one of A and/or B” is to be understood to represent any one of “A”|or “B” or “A and B.” Expressions “first,” “second,” “1st” or “2nd” or the like, used in the present disclosure may indicate various components regardless of a sequence and/or importance of the components, will be used only in order to distinguish one component from the other components, and do not limit the corresponding components.

Any component (for example: a first component) is (operatively or communicatively) coupled with/to or is connected to another component (for example: a second component), any component is directly coupled to another component or may be coupled to another component through the other component (for example: a third component).

Terms used in the present specification are used only in order to describe specific embodiments rather than limiting the present disclosure. The terms “comprises” or “have” used in the present disclosure, specify the presence of stated features, steps, operations, components, parts mentioned in the present disclosure, or a combination thereof, but do not preclude the presence or addition of one or more other features, numerals, steps, operations, components, parts, or a combination thereof.

In the disclosure, a “module” or a “~er/or” may perform at least one function or operation, and be implemented by hardware or software or be implemented by a combination of hardware and software. In addition, a plurality of “modules” or a plurality of “~ers/~ors” may be integrated in at least one module and be implemented by at least one processor (not illustrated) except for a “module” or a “~er/or” that needs to be implemented by specific hardware.

In the present disclosure, the term “signal” includes not only an electrical signal but also a sound wave signal, and the electrical signals may be either an analog signal or a digital signal. For example, the expression “audio signal” (or “noise signal”) refers to a sound wave (or radio) signal when the signal is located outside the electronic apparatus, or an electrical signal when the signal is located inside the electronic apparatus according to a position. In addition, signal processing, etc., within the electronic apparatus, as described below, may be an analog signal processing scheme or a combination of the analog signal processing scheme and a digital signal processing scheme in addition to the digital signal processing scheme.

In the present disclosure, the term “filter” refers to removing a specific component (e.g., a specific frequency range or a specific pattern). The filter may be a digital filter or an analog filter.

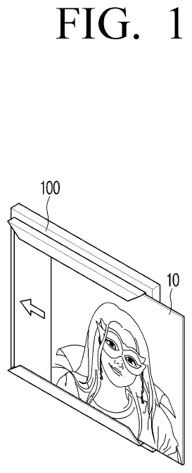

FIG. 1 is a diagram for schematically describing an electronic apparatus according to an embodiment.

According to FIG. 1, the electronic apparatus 100 according to an embodiment may output a media content or audio content (an audio). In some embodiments, the electronic apparatus 100 may output other media contents such as a video content or data; one or more multi-media contents. That is, the present disclosure is not limited to an audio content or data. In embodiments of the present disclosure, the audio content or data is used as a non-limiting example of media contents to be processed.

According to an example, the electronic apparatus may identify whether an object including a media content (e.g., an audio content) is attached to the electronic apparatus 100. According to an example, the object may be a present-shape (e.g., square) album jacket. According to an example, the electronic apparatus 100 may identify whether the object including the media content (e.g., the audio content) is attached to a predetermined position within the electronic apparatus 100.

According to an embodiment, the electronic apparatus 100 may acquire metadata when the object is attached. According to an example, when the object is attached, the electronic apparatus 100 may acquire the metadata corresponding to audio content from the object through a communication circuit. According to an example, the metadata may include the metadata related to at least one of a link to a music file included in an album corresponding to the audio content, an artist name, an album name, a track included in the album, or a playback mode.

According to an embodiment, the electronic apparatus 100 may output the media content (e.g., the audio content) through an output device (e.g., a speaker). In the present disclosure, the speaker is a non-limiting example of the output device. In some embodiments, other output devices such as a display screen may be used. According to an example, the electronic apparatus 100 may output an audio content acquired from an external apparatus (e.g., a server corresponding to a content provider) based on the acquired metadata through the speaker.

Hereinafter, various embodiments for conveniently providing the audio content by attaching a physical album type of object to the electronic apparatus 100 will be described in detail. Further, hereinafter, various embodiments for providing users with an analog music listening experience by outputting the audio content will be described.

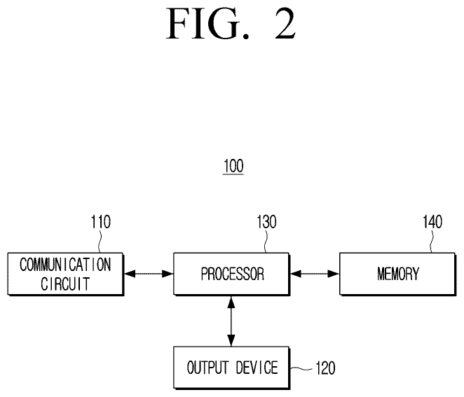

FIG. 2 is a block diagram illustrating a configuration of the electronic apparatus according to an embodiment.

According to FIG. 2, the electronic apparatus 100 may include a communication circuit 110, an output device 120 (e.g., a speaker), at least one processor 130, and memory 140.

According to an embodiment, the electronic apparatus 100 may output an audio. According to an example, the electronic apparatus 100 may be a predetermined type (e.g., a frame type) speaker apparatus that outputs the audio, but is not limited to the above example. According to an example, the electronic apparatus 100 may be a different type of apparatus that outputs the audio (e.g., a music player, etc.).

The communication circuit 110 may input and output various types of data. For example, the communication circuit 110 may transmit and receive various types of data with external apparatuses (e.g., source apparatuses), external storage media (e.g., USB memory), and external servers (e.g., web hard drives) through communication schemes such as AP-based Wi-Fi (Wireless LAN network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial, and the like.

According to one example, the communication circuit 110 may include a Bluetooth Low Energy (BLE) module. BLE refers to Bluetooth technology capable of transmitting and receiving low-power, low-capacity data in a 2.4-GHz frequency band with a reach radius of approximately 10 m. However, the present disclosure is not limited to the above examples, and the communication circuit 110 may include a Wi-Fi communication module. That is, the communication circuit 110 may include at least one of a Bluetooth Low Energy (BLE) module or a Wi-Fi communication module.

According to an embodiment, the output device 120 (e.g., the speaker) may include a tweeter for reproducing a high-frequency sound; a mid-range driver for reproducing a mid-frequency sound; a woofer for reproducing a low-frequency sound; a subwoofer for reproducing an ultra-low-frequency sound; an enclosure for separating front and rear surfaces of a speaker woofer diaphragm to generate a sound in a target low-frequency range and providing a baffle capable of attaching different types of units such as tweeters and mid-range drivers; and a crossover network for dividing electrical signal frequencies input to the speaker by frequency bands.

According to an embodiment, the output device 120 (e.g., the speaker) may output an audio signal to the outside of the electronic apparatus 100. The output device 120 (e.g., the speaker) may output multimedia playback, recording playback, various notification sounds, voice messages, and the like. The electronic apparatus 100 may include an audio output device such as the output device 120 (e.g., the speaker), or may include an output device such as an audio output terminal. In particular, the output device 120 (e.g., the speaker) may provide acquired information, information processed and produced based on the acquired information, a response result or an operation result to a user voice, etc., in a voice form.

At least one processor 130 (hereinafter, referred to as a processor) is electrically connected to the communication circuit 110, the output device 120 (e.g., the speaker), the at least one processor 130, and the memory 140 to control overall operations of the electronic apparatus 100. The processor 130 may be comprised of one or a plurality of processors. Specifically, the processor 130 may perform operations of the electronic apparatus 100 according to various embodiments of the present disclosure by executing at least one instruction stored in the memory 140.

According to an embodiment, the processor 130 may be implemented as a digital signal processor (DSP) that processes digital image signals, a microprocessor, a Graphics Processing Unit (GPU), an Artificial Intelligence (AI) processor, a Neural Processing Unit (NPU), or a Time controller (TCON). However, the processor is not limited to the above examples and may include one or more of a central processing unit (CPU), a Micro Controller Unit (MCU), a micro processing unit (MPU), a controller, an application processor (AP), a communication processor (CP), or an ARM processor, or may be defined as the corresponding term. Additionally, the processor 130 may be implemented as a System on Chip (SoC) with embedded processing algorithms, a large scale integration (LSI), or may be implemented in the form of an application specific integrated circuit (ASIC) or a Field Programmable Gate Array (FPGA).

The memory 140 may store data required for various embodiments. The memory 140 may be implemented in the form of memory embedded in the electronic apparatus 100 or in the form of memory detachable from the electronic apparatus 100, depending on a data storage purpose. For example, data for driving the electronic apparatus 100 may be stored in the memory embedded in the electronic apparatus 100, and data for extended functions of the electronic apparatus 100 may be stored in the memory detachable from the electronic apparatus 100.

In some embodiments, the memory embedded in the electronic apparatus 100 may be implemented as at least one of volatile memory (e.g., dynamic RAM (DRAM), static RAM (SRAM), or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash)), hard drive, or solid state drive (SSD). Further, the memory detachable from the electronic apparatus 100 may be implemented in forms such as memory cards e.g., compact flash (CF), secure digital (SD), micro secure digital (Micro-SD), mini secure digital (Mini-SD), extreme digital (xD), multi-media card (MMC), external memory connectable to a USB port (e.g., USB memory), and the like.

According to an embodiment, the processor 130 may identify whether an object including an audio content is attached to the electronic apparatus 100. According to an example, the object may be a predetermined-shape (e.g., square) album jacket. For example, the object may be a long-playing (LP) record album type jacket, but is not limited to the above examples. According to an example, a size of the object may be a size attachable to a specific position of the electronic apparatus 100 (e.g., a front surface of the electronic apparatus 100), but is not limited to the above examples. In some embodiments of the present disclosure, ‘attachment’ may include ‘insertion’.

According to an embodiment, the processor 130 may identify whether an object including an audio content is attached to a first position of the electronic apparatus 100. According to an example, the first position may be a position in the front surface of the electronic apparatus 100, but is not limited to the above example. In an embodiment, the first position may be a predetermined position within the electronic apparatus 100 where the object may be attached.

According to an example, it may be assumed that the object includes a Near Field Communication (NFC) label. The processor 130 may use a Near Field Communication (NFC) reader included in the electronic apparatus 100 to identify whether the object is attached to the first position. For example, the processor 130 may identify the object as being attached to the first position when the NFC label corresponding to the object is identified as being located within a predetermined distance from the electronic apparatus 100 through the NFC reader.

Alternatively, according to an example, it may also be assumed that the object includes a Radio Frequency Identification (RFID) tag. The processor 130 may also identify whether the object is attached to the first position by using an RFID reader included in the electronic apparatus 100. For example, the processor 130 may identify the object as being attached to the first position when the RFID tag corresponding to the object is identified as being located within a predetermined distance from the electronic apparatus 100 through the RFID reader, but is not limited to the above examples.

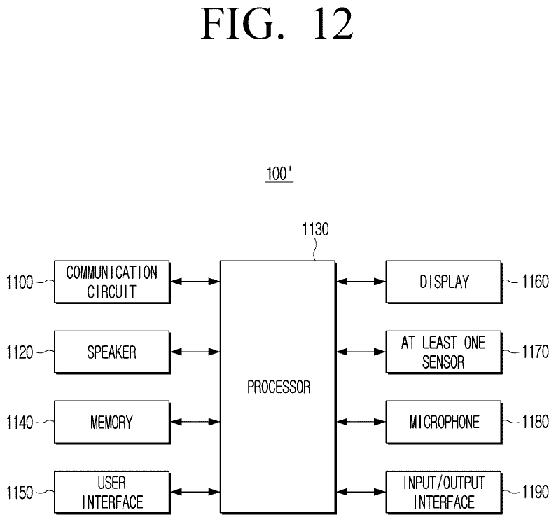

Alternatively, according to an example, the processor 130 may identify whether the object is attached to the first position based on sensing data acquired through at least one sensor (e.g., at least one sensor 1170 of FIG. 12). For example, the at least one sensor may include a camera sensor. The processor 130 may identify a quick response (QR) code included in the object through the camera sensor. The processor 130 may identify the object as being attached to the first position when the QR code is identified.

Alternatively, for example, it may be assumed that the at least one sensor includes a magnetic sensor. When the object includes a magnetic stripe, the processor 130 may identify the object as being attached to the first position based on sensing data acquired by inserting the object into a predetermined position of the electronic apparatus 100.

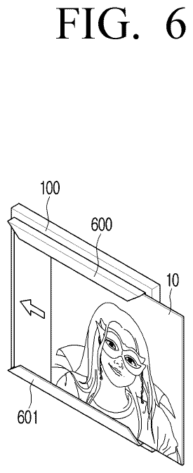

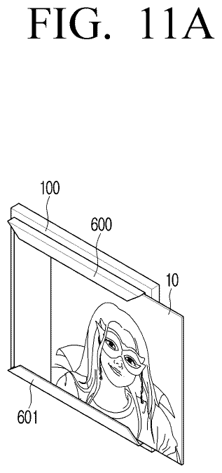

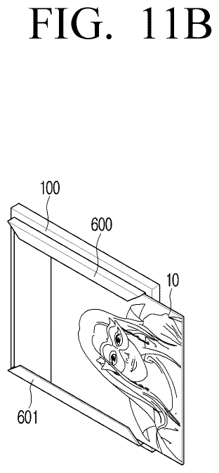

According to an example, the electronic apparatus 100 may include a configuration capable of attaching or holding the object. For example, the electronic apparatus 100 may include a sliding bracket for the object to be inserted into the electronic apparatus 100 in a sliding scheme. In one embodiment, when the object includes a magnet, the electronic apparatus 100 may include a magnetic fastening device for attaching the object to a predetermined position of the electronic apparatus 100 through magnetic force, but is not limited to the above examples. This will be described in detail with reference to FIGS. 6 and 11.

According to an embodiment, the processor 130 may acquire a metadata when the object is attached. According to an example, when the object is attached, the processor 130 may acquire the metadata corresponding to the audio content from the object through a communication circuit.

According to an example, the metadata may include the metadata related to at least one of a link to a music file included in an album corresponding to the audio content, an artist name, an album name, a track included in the album, or a playback mode. Alternatively, the metadata may include metadata related to a unique identifier of the audio content or data required for connection to a streaming service, but is not limited to the above examples.

For example, the processor 130 may acquire the metadata corresponding to the audio content from the NFC label included in the object through the NFC reader. Alternatively, for example, the processor 130 may also acquire the metadata based on the QR code or RFID tag included in the object.

According to an embodiment, the processor 130 may output the audio content through the speaker. According to an example, the processor 130 may output the audio content acquired from an external apparatus through the communication circuit based on the acquired metadata through the speaker.

According to an example, the processor 130 may acquire at least one of identification information and communication connection information corresponding to the audio content based on the metadata. The processor 130 may acquire the audio content from an external apparatus (e.g., a server corresponding to a content provider) based on at least one of the acquired identification information and communication connection information. According to an example, the processor 130 may acquire and output (or stream) the audio content from the external apparatus in real time, but is not limited to the above example.

According to an example, the identification information may include at least one of a link to a music file included in an album, an artist name, an album name, a track included in the album, a playback mode, or a unique identifier of the album, but is not limited to the above examples. According to an example, the communication connection information may be information required for establishing a communication connection with an external apparatus for streaming the audio content.

According to an example, the processor 130 may acquire the identification information and the communication connection information from the metadata based on information stored in the memory 140. For example, the memory 140 may have information mapped to each of the metadata pre-stored therein. The processor 130 may obtain the identification information and the communication connection information based on the information mapped to the metadata.

According to the above-described example, a user may conveniently receive the audio content by attaching a physical album type object to the electronic apparatus 100. Accordingly, the user may be provided with an analog music listening experience.

When the object is attached to the electronic apparatus 100, the electronic apparatus 100 may acquire a content from an external content provider based on sensing data obtained through short-range wireless communication technology or sensors and provide the content to the user, thereby enhancing user usability and convenience.

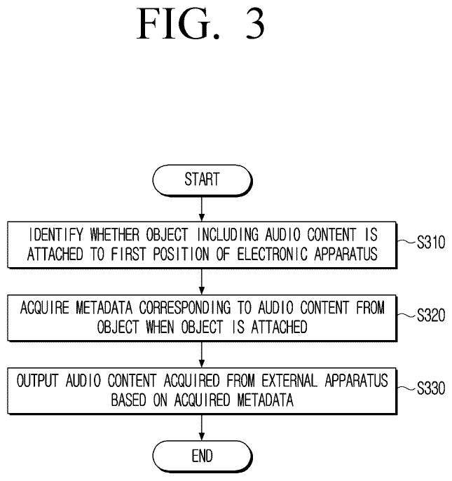

FIG. 3 is a flowchart for describing a method for operating the electronic apparatus according to an embodiment of the present disclosure.

According to FIG. 3, in an embodiment, the operating method may include an operation S310 of identifying whether an object including an audio content is attached to a first position of the electronic apparatus 100. According to an example, the electronic apparatus 100 may identify whether the object including the audio content is attached to the first position of the electronic apparatus 100.

According to an example, when the object is attached, the operating method may include an operation S320 of acquiring metadata corresponding to the audio content from the object. According to an example, when the object is attached, the electronic apparatus 100 may acquire the metadata corresponding to the audio content from the object through a communication circuit 110.

According to an embodiment, the operating method may include an operation S330 of outputting an audio content acquired from an external apparatus based on the acquired metadata. According to an example, when the metadata is obtained, the electronic apparatus 100 may acquire the audio content from the external apparatus through the communication circuit 110 based on the acquired metadata. According to an embodiment, the electronic apparatus 100 may output the acquired audio content through an output device 120 (e.g., a speaker).

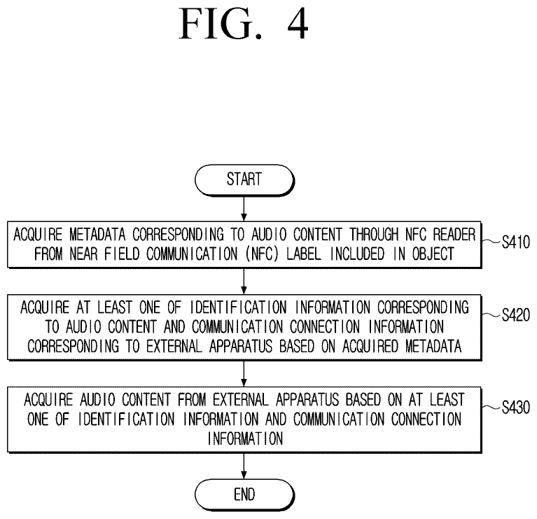

FIG. 4 is a flowchart for describing a method for acquiring an audio content according to an embodiment.

According to FIG. 4, according to an embodiment, the operating method may include an operation S410 of acquiring metadata corresponding to an audio content through an NFC reader from a Near Field Communication (NFC) label included in an object.

According to an example, the electronic apparatus 100 may further include an NFC reader. According to an example, the electronic apparatus 100 may acquire the metadata corresponding to the audio content from the NFC label included in the object through the NFC reader. For example, when the object is attached to a first position of the electronic apparatus 100, the electronic apparatus 100 may acquire the metadata corresponding to the audio content from the NFC label.

According to an embodiment, the operating method may include an operation S420 of acquiring at least one of identification information corresponding to the audio content and communication connection information corresponding to the external apparatus based on the acquired metadata.

According to an example, when the metadata is acquired from the object, the electronic apparatus 100 may acquire at least one of the identification information corresponding to the audio content and the communication connection information corresponding to the external apparatus based on the metadata.

According to an example, the identification information may include at least one of a link to a music file included in an album, an artist name, an album name, a track included in the album, a playback mode, or a unique identifier of the album. According to an example, the communication connection information may be information required for establishing a communication connection with a content provider server, including network information (e.g., address information of the content provider server, etc.) and authentication information. According to an example, when the metadata is acquired, the electronic apparatus 100 may acquire at least one of the identification information and the communication connection information corresponding to the object based on information stored in the memory 140.

According to an embodiment, the operating method may include an operation S430 of acquiring the audio content from the external apparatus based on at least one of the identification information and the communication connection information.

According to an example, the electronic apparatus 100 may establish the communication connection with the content provider server based on the acquired information. According to an example, when the communication connection with the content provider server is established, the electronic apparatus 100 may acquire the audio content corresponding to the object from the content provider server through the communication circuit 110.

According to an embodiment, the electronic apparatus 100 may output the acquired audio content through an output device 120 (e.g., a speaker). According to an example, the electronic apparatus 100 may perform decoding on the received audio content. For example, the electronic apparatus 100 may perform a decoding process of restoring an audio content received in a compressed form to its original form. According to an example, the electronic apparatus 100 may perform signal processing on the decoded audio content. According to an example, the signal processing may be different processing operations including equalizing and noise removal operations, but is not limited to the above examples.

According to an example, the electronic apparatus 100 may amplify the audio content. According to an example, the electronic apparatus 100 may include an amplifier AMP unit that amplifies the audio content. According to an example, the AMP unit may amplify the decoded audio content or the signal-processed audio content. According to an example, the AMP unit may provide the amplified audio content to the output device 120. According to an example, the output device 120 may output the amplified audio content.

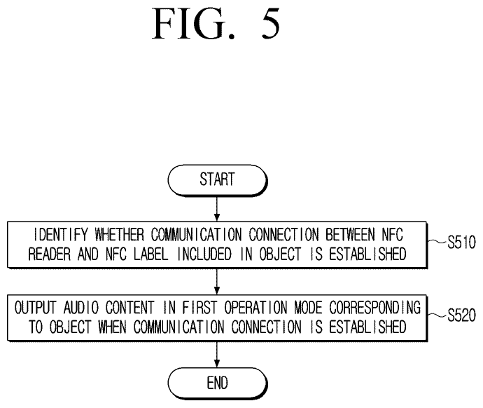

FIG. 5 is a flowchart for describing a method for outputting an audio content in a first operation mode according to an embodiment.

According to FIG. 5, according to an embodiment, the operating method may include an operation S510 of identifying whether a communication connection is established between the NFC reader and the NFC label included in the object.

According to an example, the electronic apparatus 100 may activate the NFC reader to search for NFC labels existing within a predetermined distance from the NFC reader. According to an example, when the electronic apparatus 100 identifies that an NFC label exists within a predetermined distance from the NFC reader by attaching an object to a first position, the electronic apparatus 100 may establish a communication connection with the NFC label by attempting the communication connection with the NFC label.

According to an embodiment, the operating method may include an operation S520 of outputting an audio content in a first operation mode corresponding to the object when the communication connection is established.

According to an example, when the communication connection is established between the NFC reader and the NFC label, the electronic apparatus 100 may output the audio content in the first operation mode corresponding to the object. According to an example, the first operation mode may be a streaming mode. For example, the first operation mode may be an operation mode for acquiring an audio content in real time from an external apparatus (content provider server} and outputting the audio content through the output device 120. However, the present disclosure is not limited to the above examples.

FIG. 6 is a diagram for describing a method for identifying whether an object is attached to a first position according to an embodiment.

Referring to FIG. 6, according to an embodiment, the electronic apparatus 100 may identify whether an object 10 is attached to a first position of the electronic apparatus 100.

According to an example, the electronic apparatus 100 may include a member capable of attaching or holding the object 10. For example, the electronic apparatus 100 may include sliding brackets 600 and 601 for the object 10 to be inserted into the electronic apparatus 100 in a sliding scheme. According to an example, the object 10 may be inserted into a front surface of the electronic apparatus 100 through the sliding brackets.

Alternatively, unlike illustrated in FIG. 6, the electronic apparatus 100 may include a magnetic fastening device for attaching at a predetermined position of the electronic apparatus 100 through magnetic force. In this case, a magnet may be disposed at the predetermined position within the object 10. The object 10 may be attached to the first position of the electronic apparatus 100 through the magnetic fastening device.

According to an example, the electronic apparatus 100 may identify whether the object 10 is attached. For example, the electronic apparatus 100 may identify the object 10 as being attached to the first position when the NFC label corresponding to the object 10 is identified as being located within a predetermined distance from the electronic apparatus 100 through the NFC reader. Alternatively, for example, when the electronic apparatus 100 includes an RFID reader, if an RFID tag corresponding to the object 10 is identified as being positioned within the predetermined distance from the electronic apparatus 100 through the RFID reader, the electronic apparatus 100 may identify that the object 10 is attached to the first position.

Alternatively, for example, when the electronic apparatus 100 includes a camera sensor, the electronic apparatus 100 may identify that the object 10 is attached to the first position upon identifying a QR code corresponding to the object 10. Alternatively, for example, when the object 10 includes a magnetic stripe, the electronic apparatus 100 may identify that the object 10 is attached to the first position based on sensing data acquired by inserting the object 10 into a predetermined position (a position where a magnetic sensor is attached) corresponding to the electronic apparatus 100.

However, the present disclosure is not limited to the above examples. According to an example, the electronic apparatus 100 may identify whether the object 10 is attached to the first position based on sensing data acquired through at least one sensor. This will be described in detail with reference to FIG. 11.

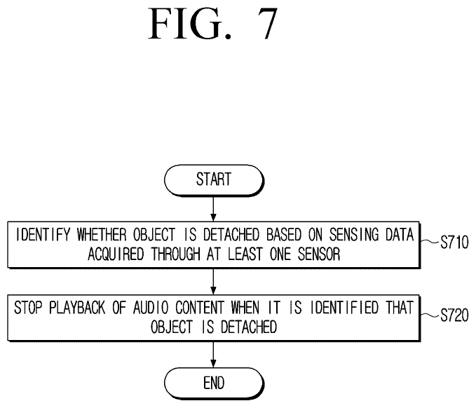

FIG. 7 is a flowchart for describing a method for stopping playback of an audio content according to an embodiment.

According to FIG. 7, according to an embodiment, the operating method may include an operation S710 of identifying whether an object is detached based on sensing data acquired through at least one sensor.

According to an example, the electronic apparatus 100 may identify whether an object is detached based on the sensing data acquired through at least one sensor. For example, the electronic apparatus 100 may identify whether the object is detached based on the sensing data acquired through a camera sensor. Alternatively, the electronic apparatus 100 may identify whether an object is detached based on the sensing data acquired through a magnetic sensor.

Alternatively, for example, the electronic apparatus 100 may identify the object 10 as being detached when the NFC label corresponding to the object 10 is identified as not being present within a predetermined distance from the electronic apparatus 100 through the NFC reader. Alternatively, for example, when the electronic apparatus 100 includes an RFID reader, if an RFID tag corresponding to the object is identified as being not present within the predetermined distance from the electronic apparatus 100 through the RFID reader, the electronic apparatus 100 may identify that the object is detached from the first position.

According to an embodiment, the operating method may include an operation S720 of stopping playback of an audio content when it is identified that the object is detached.

According to an example, the electronic apparatus 100 may stop the playback of the audio content when it is identified that the object is detached. For example, the electronic apparatus 100 may control the output device 120 to stop the playback of the audio content that is currently being streamed.

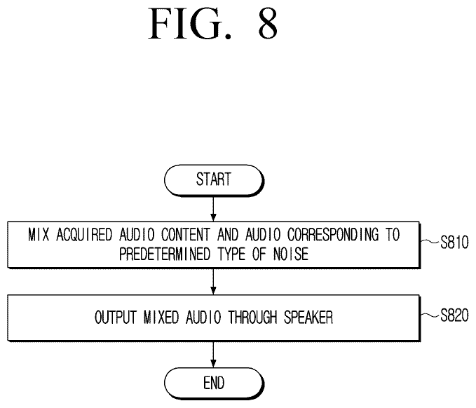

FIG. 8 is a flowchart for describing a method for outputting a mixed audio according to an embodiment.

According to FIG. 8, in accordance with an embodiment, the operating method may include an operation S810 of mixing an acquired audio content and an audio corresponding to a predetermined type of noise. According to an example, the electronic apparatus 100 may mix the acquired audio content and the audio correspondent to the predetermined type of noise.

According to an example, the electronic apparatus 100 may identify the predetermined type of noise. According to an example, the predetermined type of noise may be LP stylus noise including at least one of long playing (LP) record stylus landing noise, tonearm lifting noise, and surface noise. According to an example, an audio corresponding to the LP stylus noise may, but is not limited to, be pre-stored in the memory 140, and according to an example, the electronic apparatus 100 may also acquire an audio corresponding to the noise from an external apparatus, including a user terminal.

According to an example, the long playing (LP) record stylus landing noise may be the noise that is generated when a needle (or stylus) of the LP record player first touches the surface of the record. According to an example, the tonearm lifting noise may be the noise generated when the tonearm is lifted by the LP record player. According to an example, the surface noise may be noise generated in a section (or blank section) after playback of a music corresponding to the LP record is completed, but is not limited to the above examples.

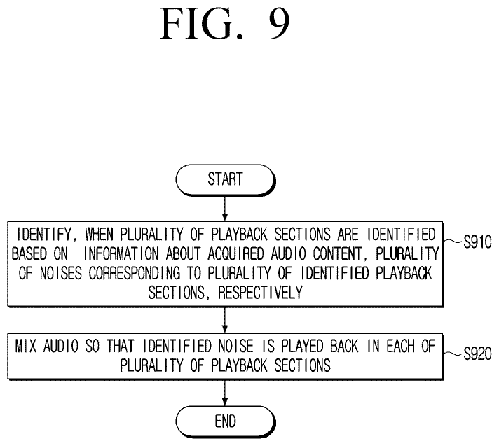

According to an example, the electronic apparatus 100 may identify a playback section corresponding to each noise and insert the noise into the identified playback section. For example, the audio corresponding to LP stylus landing noise may be inserted in a section before the audio content is played back. Alternatively, for example, the surface noise may be inserted in a section after playback of the audio content is completed. Alternatively, for example, the tonearm lifting noise may be inserted in a time section after a preset time has elapsed following completion of playback of the audio content. However, the present disclosure is not limited to the above examples. This will be described in detail with reference to FIG. 9.

Alternatively, according to an example, the predetermined type of noise may include not only LP stylus noise, but also noise corresponding to a compact disc (CD), noise corresponding to a mini disk (MD), and noise corresponding to a cassette tape. For example, the noise corresponding to the tape may include noise corresponding to mechanical sounds generated at the start or end of tape playback. Alternatively, for example, noise corresponding to a CD may include at least one of noise generated in a process of converting a digital signal to an analog signal, optical pickup focusing noise, and tracking noise. Alternatively, for example, noise corresponding to an MD may include, but is not limited to, noise generated by mechanical operation of an MD player.

According to an example, information about the audio corresponding to each type of noise may be pre-stored in the memory 140, but the present disclosure is not limited to the above examples. According to an example, the electronic apparatus 100 may acquire an audio corresponding to the aforementioned noise from the external apparatus including the user terminal.

According to an embodiment, the operating method may include an operation S820 of outputting a mixed sound through a speaker. According to an example, the electronic apparatus 100 may output an audio mixed with noise through the speaker.

FIG. 9 is a flowchart for describing a method for mixing audio according to an embodiment.

According to FIG. 9, according to an embodiment, the operating method may include, when a plurality of playback sections are identified based on information about the acquired audio content, an operation S910 of identifying a plurality of noises corresponding to each of the identified plurality of playback sections.

According to an example, the electronic apparatus 100 may acquire the information about the audio content. According to an example, the information about the audio content may include information about playback time corresponding to each sub-content (e.g., track) included in the audio content. According to an example, the information about the playback time may include information about a playback start time and a playback end time of each track. According to an example, the electronic apparatus 100 may acquire the information about the audio content together with the audio content from the external apparatus.

According to an example, the electronic apparatus 100 may identify a playback section within the audio content. According to an example, the electronic apparatus 100 may identify the playback section based on the information about the audio content. The electronic apparatus 100 may identify a first playback section before the music is played back. Alternatively, according to an example, the electronic apparatus 100 may identify a second playback section corresponding to a time period from a time point when playback of a first sub-content included in the audio content is completed until a time point before playback of a second sub-content following the first sub-content begins.

According to an example, the electronic apparatus 100 may identify the long playing (LP) record stylus landing noise as noise corresponding to the first playback section. Alternatively, according to an example, the electronic apparatus 100 may identify the surface noise as noise corresponding to the second playback section. However, the present disclosure is not limited to the above examples.

Alternatively, according to an example, the electronic apparatus 100 may identify a third playback section from a time point when playback of a last sub-content included in the audio content is completed to a time point when a predetermined time has elapsed. Alternatively, according to an example, the electronic apparatus 100 may identify a fourth playback section from a time point when the aforementioned third playback section ends to a time point when a predetermined time has elapsed.

According to an example, the electronic apparatus 100 may identify the surface noise as noise corresponding to the third playback section. According to an example, the electronic apparatus 100 may identify the tonearm lifting noise as noise corresponding to the fourth playback section.

According to an embodiment, the operating method may include an operation S920 of mixing an audio so that the noise identified in each of the plurality of playback sections is played back.

According to an example, when noise corresponding to each of the plurality of playback sections corresponding to the audio content is identified, the electronic apparatus 100 may mix the audio so that the noise is played back in the corresponding playback section.

For example, the electronic apparatus 100 may mix the audio content with audio corresponding to noise such that the long-playing (LP) record stylus landing noise is played back during the first playback section. Alternatively, for example, the electronic apparatus 100 may mix the audio such that the surface noise is played back during the second playback section. Alternatively, for example, the electronic apparatus 100 may mix the audio such that the surface noise is played back during the third playback section. Alternatively, for example, the electronic apparatus 100 may identify the tonearm lifting noise as noise corresponding to the fourth playback section.

According to an example, the electronic apparatus 100 may output an audio content mixed with the audio corresponding noise through the speaker.

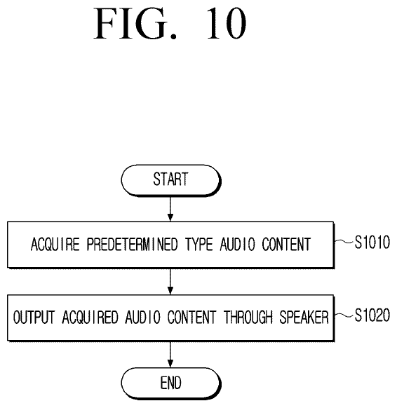

FIG. 10 is a flowchart for describing a method for outputting a predetermined type audio content according to an embodiment.

According to FIG. 10, according to an embodiment, the operating method may include an operation S1010 of acquiring a predetermined type audio content.

According to an example, the electronic apparatus 100 may acquire the predetermined type audio content. According to an example, the predetermined type audio content may be an audio content corresponding to different types of audio formats. For example, the predetermined type audio content may include any one of a general 2-channel audio content, a 2-channel audio content to which a Lossless algorithm is applied to improve the quality of an audio source, and an audio content to which an algorithm for converting the audio source into a multi-dimensional surround audio is applied (for example, Dolby ATMOS multi-channel audio source, etc.), but is not limited to the above examples.

According to an example, the electronic apparatus 100 may acquire the predetermined type audio content based on a user input. For example, when the electronic apparatus 100 receives a user input for playing a 2-channel audio content to which a Lossless algorithm is applied, the electronic apparatus 100 may acquire a 2-channel audio content to which a Lossless algorithm is applied from an external apparatus through the communication circuit 110 based thereon. Alternatively, for example, when the electronic apparatus 100 receives a user input for playing an audio content to an algorithm for converting into three-dimensional surround audio is applied, the electronic apparatus 100 may also acquire an audio content to which the algorithm for converting into three-dimensional surround audio is applied from the external apparatus through the communication circuit 110 based thereon.

According to an embodiment, the operating method may include an operation S1020 of outputting the acquired audio content through the speaker. According to an example, the electronic apparatus 100 may output the acquired type audio content through the output device 120 (e.g., the speaker). For example, the electronic apparatus 100 may output, through the output device 120, the 2-channel audio content to which the lossless algorithm is applied, acquired based on the user input. Alternatively, for example, the electronic apparatus 100 may output, through the output device 120, the audio content to which the algorithm for converting into the three-dimensional surround audio is applied, acquired based on the user input.

However, the present disclosure is not limited to the above examples. According to an example, the electronic apparatus 100 may also output the general 2-channel audio content through the output device 120 when no separate user input is received.

FIGS. 11A and 11B are diagrams for describing a method for identifying an attachment direction of an object according to an embodiment.

Referring to FIGS. 11A and 11B, according to an embodiment, the electronic apparatus 100 may identify the attachment direction of the object 10.

According to an example, the electronic apparatus 100 may identify the attachment direction of the object 10 based on sensing data acquired through at least one sensor. According to an example, the at least one sensor may include a camera sensor or an infrared sensor. According to an example, the electronic apparatus 100 may identify the attachment direction of the object 10 or a surface to which the object 10 is attached based on the sensing data acquired through at least one sensor of the camera sensor or the infrared sensor. Alternatively, according to an example, the electronic apparatus 100 may use the sensing data acquired from each of the camera sensor and the infrared sensor in combination. According to an example, the attachment direction of the object 10 may refer to a direction in which the object is rotated and attached to the electronic apparatus 100, as illustrated in FIGS. 11A and 11B, but is not limited to the above examples.

Alternatively, according to an example, the electronic apparatus 100 may also identify the attachment direction of the object 10 or the surface to which the object 10 is attached based on sensing data acquired through at least one sensor (e.g., a magnetic sensor) included in the sliding brackets 600 and 601.

According to an example, when the object 10 is attached to the electronic apparatus 100 in a first attachment direction as illustrated in FIG. 11A, the audio content may be provided in a corresponding playback option scenario. For example, the playback option scenario corresponding to the first attachment direction may be a forward playback mode. According to an example, the forward playback mode may be a mode in which a sub-audio content is played back in an order listed in a playlist.

Alternatively, according to an example, when the object 10 is attached to the electronic apparatus 100 in a second attachment direction as illustrated in FIG. 11B, the audio content may be provided in a corresponding playback option scenario corresponding to a second attachment direction. For example, the playback option scenario corresponding to the second attachment direction may be a backward playback mode. According to an example, the backward playback mode may be a mode in which the sub-audio content is played back in an order opposite to the order listed in the playlist (or backward playback mode).

However, the present disclosure is not limited to the above examples. In an embodiment, the object 10 may be attached to the electronic apparatus 100 in an attachment direction different from the attachment directions illustrated in FIGS. 11A and 11B. According to an example, the playback option scenario may include different types of playback modes including a forward playback mode, a backward playback mode, a repeat playback mode, and a shuffle playback mode, and information about the attachment direction corresponding to each playback option scenario may be stored in the memory 140. The electronic apparatus 100 may identify the playback option scenario based on the direction in which the object 10 is attached to the electronic apparatus 100, and may provide the audio content based thereon.

According to an embodiment, the electronic apparatus 100 may identify a playback order of at least one sub-content included in the audio content based on the identified attachment direction. According to an example, the at least one sub-content may refer to at least one track included in the audio content. According to an example, the electronic apparatus 100 may identify the playback order of the sub-content based on the attachment direction, and control the speaker to output the sub-content according to the identified playback order.

According to an embodiment, the electronic apparatus 100 may identify the playback order based on the surface to which the object 10 is attached. According to an example, the surface to which the object 10 is attached may be a front surface or a rear surface. According to an example, the electronic apparatus 100 may identify whether the attachment surface is the front surface or the rear surface based on the sensing data acquired from the camera sensor. Alternatively, the electronic apparatus 100 may identify whether the attachment surface is the front surface or the rear surface based on the sensing data acquired from the infrared sensor.

Alternatively, according to an example, the electronic apparatus 100 may identify whether the attachment surface is the front surface or the rear surface based on the NFC label. For example, when the NFC label is included in each of the front surface and the rear surface of the object 10, the electronic apparatus 100 may identify whether the attachment surface is the front surface or the rear surface based on information acquired from the NFC label.

Alternatively, according to an example, the electronic apparatus 100 may identify whether the attachment surface is the front surface or the rear surface based on the RFID tag. For example, when the RFID tag is included in each of the front surface and the rear surface of the object 10, the electronic apparatus 100 may identify whether the attachment surface is the front surface or the rear surface based on information acquired from the RFID tag.

According to an example, the electronic apparatus 100 may also identify whether the attachment surface is the front surface or the rear surface by using sensing data acquired from a sensor together with information obtained from a near-field communication circuit (NFC reader or RFID reader).

According to an example, when the attachment surface is the front surface, the electronic apparatus 100 may play back a sub-content corresponding to the front surface and then play a sub-content corresponding to the rear surface. However, the present disclosure is not limited to the above examples. According to an example, the electronic apparatus 100 may play the sub-content in a default playback mode when the attachment surface is the front surface and play back the sub-content in a backward playback mode when the attachment surface is the rear surface.

According to an example, the electronic apparatus 100 may change a playback mode based on a user input. For example, when a user input corresponding to a random playback mode is received from an external electronic apparatus 100 (e.g., a user terminal) through a communication circuit, the electronic apparatus 100 may randomly play back the sub-content.

According to an example, a plurality of objects may be attached to the electronic apparatus 100. For example, a first object and a second object may be attached to a first position within the electronic apparatus 100 and a second position within the electronic apparatus 100, respectively. According to an example, the second position may be a position within the electronic apparatus 100 that is different from the first position. For example, the second object may be attached in a stacked state with the first object. According to an example, when the plurality of objects are attached, the electronic apparatus 100 may play back an audio content corresponding to each object in a predetermined order. For example, the electronic apparatus 100 may start playback for the second object after playback for the first object that is inserted first is completed. Alternatively, the electronic apparatus 100 may also randomly play back the audio content corresponding to the first object and the audio content corresponding to the second object.

According to an example, the electronic apparatus 100 may receive a user input using a neural network model trained to perform voice recognition. For example, when a user voice for playing back a specific track in the audio content is received through a microphone, the electronic apparatus 100 may input the user voice into the trained neural network model, identify a user command, and play back the specific track based on the identified user command.

FIG. 12 is a block diagram illustrating a detailed configuration of the electronic apparatus according to an embodiment.

FIG. 12 illustrates the electronic apparatus 100′. In some embodiments, the electronic apparatus 100′ may correspond to or may be the electronic device 100 of FIG. 2. The electronic apparatus 100′ may include a communication circuit 1110, a speaker 1120, at least one processor 1130, a memory 1140, a user interface 1150, a display 1160, at least one sensor 1170, a microphone 1180, and an input/output interface 1190.

In some embodiments, the communication circuit 1110 of FIG. 12 may correspond to or may be the communication circuit 110 of FIG. 2. In some embodiments, the speaker 1120 of FIG. 12 may correspond to or may be the output device 120 of FIG. 2. In some embodiments, the memory 1140 of FIG. 12 may correspond to or may be the memory 140 of FIG. 2.

The user interface 1150 is a component for an electronic apparatus 100′ to perform interaction with a user. For example, the user interface 1150 may include at least one of a touch sensor, a motion sensor, a button, a jog dial, a switch, a microphone, or a speaker, but is not limited to the above examples.

In some embodiments, the display 1160 of FIG. 12 may correspond to or may be the output device 120 of FIG. 2. In some embodiments, the speaker 1120 and/or the display 1160 may be included in the output device 120 of FIG. 2.

The display 1160 may be implemented as a display including self-emitting elements or a display including non-self-emitting elements and a backlight. For example, the display 160 may be implemented as various types of displays such as Liquid Crystal Display (LCD), Organic Light Emitting Diodes (OLED) display, Light Emitting Diodes (LED), micro LED, Mini LED, Plasma Display Panel (PDP), Quantum dot (QD) display, Quantum dot light-emitting diodes (QLED), and the like. The display 160 may also include a driving circuit that can be implemented in forms such as a-si TFT, low temperature poly silicon (LTPS) TFT, OTFT organic TFT, and the like, as well as a backlight unit.

The at least one sensor 1170 (hereinafter, referred to as a sensor) may include a plurality of sensors of various types. The sensor 1170 may measure physical quantities or detect an operating state of the electronic apparatus 100′, and convert the measured or detected information into electrical signals. The sensor 1170 may include a camera (or camera sensor), and the camera may include a lens that focuses visible light and other optical signals reflected and received by an object onto an image sensor, and an image sensor capable of detecting visible light and other optical signals. Here, the image sensor may include a 2D pixel array divided into a plurality of pixels. Alternatively, the sensor 1170 may include a temperature sensor or an infrared sensor.

The microphone 1180 may refer to a module that acquires sound and converts it into an electrical signal, and may be a condenser microphone, a ribbon microphone, a moving coil microphone, a piezoelectric microphone, a carbon microphone, or a Micro Electro Mechanical System microphone (MEMS). Additionally, the microphone 1180 may be implemented in an omnidirectional, bidirectional, unidirectional, sub-cardioid, super-cardioid, or hyper-cardioid scheme. According to an embodiment, the electronic apparatus 100′ may include the microphone 1180 and an inner microphone, and the microphone 1180 may be positioned relatively on the outside of the body. According to an example, the electronic apparatus 100′ may acquire an audio signal including external noise through the microphone 180. According to an embodiment, the microphone 1180 may be disposed in a direction opposite to a direction in which the speaker 1120 emits a sound.

The input/output interface 1190 may be any one interface of a high-definition multimedia interface (HDMI), mobile high-definition link (MHL), a universal serial bus (USB), a display port (DP), a thunderbolt, a video graphics array (VGA) port, an RGB port, a D-subminiature (SUB), and a digital visual interface (DVI). The input/output interface 190 may input/output at least one of an audio signal and a video signal. According to an implementation example, the input/output interface 1190 may include a port inputting/outputting only the audio signal and a port inputting/outputting only the video signal as separate ports, or may be implemented as one port which inputs/outputs both the audio signal and the video signal. In an embodiment, the electronic apparatus 100′ may transmit at least one of audio and video signals to an external apparatus (for example, an external display apparatus or an external speaker) through the input/output interface 1190. Specifically, an output port included in the input/output interface 190 may be connected to the external apparatus, and the electronic apparatus 100′ may transmit at least one of audio and video signals to the external apparatus through the output port.

According to the above-described example, a user may receive the audio content by attaching a physical album type object to the electronic apparatus 100′. Accordingly, the user may be provided with an analog music listening experience.

When the object is attached to the electronic apparatus 100′, the electronic apparatus 100′ may acquire a content from an external content provider based on sensing data obtained through short-range wireless communication technology or sensors and provide the content to the user, thereby enhancing user usability and convenience.

According to an embodiment of the disclosure, one or more embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the display apparatus (for example, the display apparatus A) according to the disclosed embodiments. In the case in which a command is executed by the processor, the processor may directly perform a function corresponding to the command or other components may perform the function corresponding to the command under a control of the processor. The command may include codes provided or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

According to an embodiment, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily provided.

Each of components (for example, modules or programs) according to one or more embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although example embodiments of the present disclosure have been illustrated and described hereinabove, the present disclosure is not limited to the abovementioned specific example embodiments, but may be variously modified by those skilled in the art to which the present disclosure pertains without departing from the gist of the present disclosure as disclosed in the accompanying claims. These modifications should also be understood to fall within the scope and spirit of the present disclosure.

What is claimed is:

1. An electronic apparatus comprising:
a communication circuit;
a speaker;
at least one processor comprising a processing circuit, wherein the at least one processor is operatively connected with the communication circuit and the speaker; and
a memory storing instructions, wherein the instructions, when executed by the at least one processor individually or collectively, cause the electronic apparatus to:
identify whether an object corresponding to an audio content is attached to a first position of the electronic apparatus,
based on identifying that the object is attached to the first position, acquire metadata corresponding to the audio content from the object through the communication circuit,
obtain, from an external apparatus through the communication circuit, the audio content corresponding to the acquired metadata, and
output, through the speaker, the obtained audio content.

2. The electronic apparatus of claim 1, further comprising a Near Field Communication (NFC) reader,
wherein the instructions, when executed by the at least one processor individually or collectively, further cause the electronic apparatus to:
acquire, from an NFC label included in the object via the NFC reader, metadata corresponding to the audio content,
acquire, based on the acquired metadata, at least one of identification information corresponding to the audio content and communication connection information corresponding to the external apparatus, and
acquire the audio content from the external apparatus, based on at least one of the identification information and the communication connection information.

3. The electronic apparatus of claim 2, wherein the instructions, when executed by the at least one processor individually or collectively, further cause the electronic apparatus to:
identify whether a communication connection between the NFC reader and the NFC label included in the object is established, and
based on identifying the communication connection is established, output the audio content in a first operation mode corresponding to the object.

4. The electronic apparatus of claim 1, further comprising at least one sensor,
wherein the instructions, when executed by the at least one processor individually or collectively, further cause the electronic apparatus to identify whether the object is attached to the first position based on sensing data acquired through the at least one sensor.

5. The electronic apparatus of claim 4, wherein the instructions, when executed by the at least one processor individually or collectively, further cause the electronic apparatus to:
identify whether the object is detached based on the sensing data acquired through the at least one sensor, and
based on identifying that the object is detached, stop playback of the audio content.

6. The electronic apparatus of claim 1, wherein the instructions, when executed by the at least one processor individually or collectively, further cause the electronic apparatus to:
mix the obtained audio content and an audio corresponding to a predetermined type of noise, and
output the mixed audio through the speaker.

7. The electronic apparatus of claim 6, wherein the predetermined type of noise is a long playing (LP) stylus noise including at least one of long playing (LP) record stylus landing noise, tonearm lifting noise, and surface noise, and
when the instructions, when executed by the at least one processor individually or collectively, further cause the electronic apparatus to, based on a predetermined playback section being identified based on information about the obtained audio content, mix the audio to output the LP stylus noise in the identified playback section.

8. The electronic apparatus of claim 6, wherein, when the instructions are individually or collectively executed by the at least one processor, the instructions further cause the electronic apparatus to:
based on a plurality of playback sections being identified based on information about the obtained audio content, identify a plurality of noises corresponding to the plurality of identified playback sections, respectively, and
mix the audio so that the identified noise is played back in each of the plurality of playback sections.

9. The electronic apparatus of claim 1, wherein, when the instructions are individually or collectively executed by the at least one processor, the instructions further cause the electronic apparatus to:
acquire a predetermined type of audio content, and
output the obtained audio content through the speaker.

10. The electronic apparatus of claim 1, further comprising at least one sensor,
wherein the instructions, when executed by the at least one processor individually or collectively, further cause the electronic apparatus to:
identify an attachment direction of the object based on sensing data acquired through the at least one sensor, and
identify a playback order of at least one sub-content included in the audio content based on the identified attachment direction.

11. A method for operating an electronic apparatus, the method comprising:
identifying whether an object corresponding to an audio content is attached to a first position of the electronic apparatus;
based on identifying that the object is attached to the first position, acquiring metadata corresponding to the audio content from the object through a communication circuit;
obtaining, based on the acquired metadata, the audio content from an external apparatus through the communication circuit; and
outputting, through a speaker, the audio content.

12. The method of claim 11, wherein the electronic apparatus further comprises a Near Field Communication (NFC) reader, and
wherein the method further comprises:
acquiring, through the NFC reader from an NFC label included in the object, metadata corresponding to the audio content;
acquiring, based on the acquired metadata, at least one of identification information corresponding to the audio content and communication connection information corresponding to the external apparatus; and
acquiring the audio content from the external apparatus, based on at least one of the identification information and the communication connection information.

13. The method of claim 12, further comprising:
identifying whether a communication connection between the NFC reader and the NFC label included in the object is established; and
based on identifying that the communication connection is established, outputting the audio content in a first operation mode corresponding to the object.

14. The method of claim 11, wherein the identifying whether the object is attached to the first position, comprises identifying whether the object is attached to the first position, based on sensing data acquired through at least one sensor.

15. A non-transitory storage medium storing computer-readable instructions, wherein the instructions. When executed by at least one processor of an electronic apparatus, cause the electronic apparatus to perform the method of claim 11.

16. An electronic apparatus comprising:
a communication circuit;
an output device;
at least one processor comprising a processing circuit, wherein the at least one processor is operatively connected with the communication circuit and the output device; and
a memory storing instructions,
wherein the instructions, when executed by the at least one processor individually or collectively, cause the electronic apparatus to:
identify whether an object corresponding to a media content is attached to a first position of the electronic apparatus,
based on identifying the object is attached to the first position, acquire metadata corresponding to the media content from the object through the communication circuit,
obtain, from an external apparatus through the communication circuit, the media content corresponding to the acquired metadata, and
output, through the output device, the obtained media content.

17. The electronic apparatus of claim 16, further comprising a Near Field Communication (NFC) reader,
wherein the instructions, when executed by the at least one processor individually or collectively, further cause the electronic apparatus to:
acquire, from a NFC label included in the object via the NFC reader, metadata corresponding to the media content,
acquire, based on the acquired metadata, at least one of identification information corresponding to the media content and communication connection information corresponding to the external apparatus, and
acquire the media content from the external apparatus, based on at least one of the identification information and the communication connection information.

18. The electronic apparatus of claim 17, wherein the instructions, when executed by the at least one processor individually or collectively, further cause the electronic apparatus to:
identify whether a communication connection between the NFC reader and the NFC label included in the object is established, and
based on identifying that the communication connection is established, output the media content in a first operation mode corresponding to the object.

19. The electronic apparatus of claim 16, further comprising at least one sensor,
wherein the instructions, when executed by the at least one processor individually or collectively, further cause the electronic apparatus to identify whether the object is attached to the first position based on sensing data acquired through the at least one sensor.

20. The electronic apparatus of claim 19, wherein the instructions, when executed by the at least one processor individually or collectively, further cause the electronic apparatus to:
identify whether the object is detached based on the sensing data acquired through the at least one sensor, and
based on identifying that the object is detached, stop playback of the media content.
